(19) United States
(12) Patent Application Publication
(10) Pub. No.: US 2018/0228305 A1
(43) Pub. Date: Aug. 16, 2018

(54) RETAINING BODY, RETAINING DEVICE AND METHOD FOR INSTALLING A RETAINING DEVICE

(71) Applicant: TESA SE, Norderstedt (DE)

(72) Inventors: Franz FASTERMANN, Elmshorn (DE); Tanja STRIBERNY, Hamburg (DE); Martje MASSON, Hamburg (DE); Oliver KELLER, Hamburg (DE)

(73) Assignee: TESA SE, Norderstedt (DE)

(21) Appl. No.: 15/754,128

(22) PCT Filed: Aug. 10, 2016
(86) PCT No.: PCT/EP2016/069002

§ 371 Date: Feb. 21, 2018

(30) Foreign Application Priority Data
Aug. 21, 2015 (DE) 10 2015 215 980.9

(51) Int. Cl. A47G 1/17; F16B 11/00; F16B 45/00; A47G 1/20; A47G 29/00; C09J 5/04; C09J 7/38

(52) U.S. Cl. CPC A47G 1/175; F16B 11/006; F16B 45/00; C09J 2201/128; A47G 29/00; C09J 5/04; C09J 7/38; A47G 1/20

(57) ABSTRACT

The invention relates to a retaining body for fastening on a surface, wherein the retaining body can be fixed on the surface by means of a double-sided adhesive strip with two opposite retaining surfaces, wherein the retaining body has a basic body with a flat rear surface and a front surface, which is located opposite the rear surface, wherein the front surface of the basic body has formed on it a carrying element which projects from a plane of the basic body, wherein the basic body has, on the front surface, a reinforcing structure with reinforcing elements, wherein the reinforcing elements subdivide the front surface of the basic body into at least two differently sized pressure-exerting surfaces.

The present invention relates to a retaining body for fastening on a surface by means of an adhesive strip which is effective on two sides according to the preamble of claim 1, to a retaining device having such a retaining body and to a method for installing a retaining device.

Retaining bodies which are fastenable in a self-adhesive manner for attaching objects to walls and other surfaces are known in diverse embodiments. Such retaining bodies are used in order to fasten objects, such as, for example, framed pictures, on vertical wall surfaces or on wall coverings without any tools. Such retaining bodies are commercially available, for example, as self-sealing hooks or adhesive hooks. In this case, these are usually retaining bodies with a basic body which comprises a flat, smooth rear surface. The rear surface of the retaining body can be glued to a surface or a wall with a flat adhesive means which is effective on two sides, for example an adhesive strip which is effective on two sides. Once the retaining body has been attached, a protruding carrier element, which is realized, for example, in a hook-shaped or mushroom-shaped manner, extends from a visible side, which is remote from the wall or surface, into space such that an object is able to be suspended on the carrier element.

In this case, the adhesive means, which is effective on two sides, can already have been attached on the rear surface of the retaining body by the manufacturer. The user then pulls a protective foil, which is arranged on the adhesive surface, away from the main surface, which is located opposite the rear surface of the retaining body, and can consequently fasten the retaining body in an adhesive manner. Means which are adhesive on two sides and are provided separately, for example adhesive tape or adhesive strip which is effective on two sides, are also known. In the case of said means, the two adhesive main surfaces are covered by a removable protective foil which has to be removed prior to installing the retaining body.

In addition, also commercially available are removable self-sealing means which, after adhesion, can be detached from the glue joint between wall and retaining body as a result of stretching and expanding in a direction approximately parallel to the wall such that the retaining body can be removed from the substrate without damaging the same. Self-sealing articles of this type are disclosed, for example in patent applications DE 33 31 016 A1 or DE 42 22 849 A1. Said adhesive strips are usually glued behind the retaining body such that a portion of the adhesive strip, which can be gripped by hand and is realized in a non-adhering manner, remains reachable for the stretching and debonding.

EP 0 590 391 A1 discloses a detachable, self-sealing hook which is combined with an adhesive foil, the hook being debondable as a result of stretching the adhesive strip in the direction of the wall plane. To this end, a basic body, on which the adhesive strip is attached, carries a hook-shaped projection for the suspending of objects.

EP 1 831 324 A1 discloses a retaining body with a special surface structure which changes its reflex characteristics when pressed and thus indicates the regions which have already been pressed. The production of said surface structure, however, is expensive and cost-intensive.

US 2007/0295436 A1 discloses a retaining device having a frame and regions with reduced wall thickness located therein, wherein self-sealing adhesive strips attached on the rear surface of the retaining device are able to be pressed through the regions with the reduced wall thickness by means of a tool. The adhesive strips, in this case, are able to be pulled undone. However, the disadvantage of said solution is that an additional tool is required for pressing the retaining device, and the symmetrical arrangement of the pressing surfaces which leaves the forces actually working on the retaining device unconsidered.

U.S. Pat. No. 4,309,011 A discloses a retaining body with rods which are arranged in a cruciform manner and which are to distribute the forces acting on the retaining device from the point of the introduction of force inside the outline of an adhesive foil onto said adhesive foil. The disadvantage in this connection, however, is that, depending on the arrangement of the retaining element at least one of the rods is not under pressure and consequently the rods do not press onto the adhesive in a uniform manner.

In the case of generic retaining devices, insufficient moistening of the substrate by the adhesive of the adhesive strip is critical above all in the local area over the load-applying structure. Tensile stresses, which promote the unpeeling of the adhesive surface from the surface, which can result in failure of the retaining device, are active here.

It is the object of the invention to provide a retaining body and a method which overcome the disadvantages known from the prior art and, with identical dimensions, enable a better adhesion result and consequently heavier loads or with an identical load ensure a more stable adhesion result.

The object is achieved by a retaining body with the features of claim 1. To this end, reinforcing elements, which divide the front surface of the basic body into at least two differently sized pressing surfaces, are realized on the basic body of the retaining body. As a result, with the identical pressing force on the two pressing surfaces, a stronger surface pressing onto an adhesive strip fastened between the retaining body and the wall surface is achieved on the smaller pressing surface than on the larger pressing surface. Consequently, a correspondingly greater pressing surface acts on the adhesive surface in a region of the adhesive strip corresponding to the smaller pressing surface such that overall an improved adhesion result can be obtained. It is possible according to the invention to choose the adhesive force by dimensioning the surface areas of the pressing surfaces in a targeted manner such that said adhesive force is greater in certain portions.

Advantageous further developments and improvements of the retaining body disclosed in the independent claim are described as a result of the measures realized in the dependent claims.

Proceeding from a point of applied force, there is preferably provided at least one pressing surface which is arranged in the opposite direction to the main load direction and there is preferably provided at least one pressing surface which is arranged in the main load direction and which is greater than the pressing surface which is arranged in the opposite direction. When the retaining body is attached to a perpendicular surface, the main load direction is defined by the weight of an object suspended on the retaining body. In this case, preferably at least one smaller pressing surface is provided above the carrier element and at least one larger retaining surface is provided below the carrier element.

According to an advantageous embodiment, it is provided that the reinforcing elements divide the front surface into at least three pressing surfaces, the sum of the pressing surfaces arranged in the main load direction proceeding from the point of applied force preferably being greater than the sum of the pressing surfaces arranged in the opposite direction proceeding from the point of applied force. An optimum ratio of adhesion result and rigidity of the retaining body can be obtained as a result of the at least three pressing surfaces.

According to an advantageous embodiment, it is provided that the reinforcing elements are formed in one piece with and on the retaining body. A particularly favorable production of the retaining body is possible as a result of a one-piece, integral reinforcing structure. In addition, the reinforcing structure is consequently able to be integrated in a particularly secure manner in the retaining body.

According to an advantageous further development, it is provided that in the view of the front surface of the retaining body, the surface areas of the reinforcing elements are smaller than the surface areas of the pressing surfaces. In order to allow sufficient space for the pressing surfaces, the reinforcing elements should not take up too much surface.

According to another advantageous further development, it is provided that a normal projection of the carrier element onto the rear surface of the retaining body lies outside the corresponding normal projections of the pressing surfaces. Consequently, the pressing surfaces are easily accessible and can be easily pressed with a fingertip.

According to another advantageous further development, it is provided that the basic body is scarfed on one side. A one-sided scarfing is to be understood in this context as a tapering of the cross section of the basic body in the direction of the upper edge.

According to another advantageous further development, it is provided that the retaining body is produced on the basis (i.e. with at least 50% by weight) of a thermoplastic material. Thermoplastic materials comprise a comparatively high strength and are compatible with the adhesive means of the adhesive strip, which is effective on two sides, used for fastening. It is particularly advantageous, in this case, when the material of the retaining body is fiber-reinforced. As a result of using glass fibers or carbon fibers, the strength of the thermoplastic material can be further increased, and the risk of breaks reduced. In this case, the fiber proportion, in a preferred manner, is between 20 percent by weight and 40 percent by weight, as a result of which the strength of the retaining body can be increased. Higher fiber proportions are possible.

According to another advantageous further development, it is provided that the retaining body is produced on the basis of a polyether ether ketone, the polyether ether ketone preferably being reinforced with carbon fibers. Polyether ether ketones are high-strength and high-temperature resistant plastics materials which are advantageous for certain applications where it is a question of high strength and high rigidity with low weight. Said strength can be increased further by embedding (carbon) fibers.

According to another advantageous further development, it is provided that the reinforcing elements converge in a, for example oval, base, wherein the carrier element rises out the basic body from said base. The base consequently forms the point of force application. The reinforcing elements can develop their effect particularly well and can increase the flexural rigidity of the retaining body particularly well when they converge in an advantageous manner in the base of the carrier element.

An advantageous embodiment is characterized in that the carrier element is realized in the form of a sloping elliptical truncated cone or in the form of a rose thorn with a tapering end. On the one hand, objects with small eyelets are also able to be suspended on the retaining body as a result of such a design, on the other hand said design leads to the forces, which act on the carrier element, being introduced favorably into the base or into the basic body.

In addition, it is provided advantageously that the carrier element carries a support plate on its free end. As a result of a support plate, objects with larger eyelets can also be suspended on the retaining body or the risk of the object slipping on the carrier element can be reduced.

According to a preferred embodiment, one smaller pressing surface of the pressing surfaces and/or two smaller pressing surfaces of the at least three pressing surfaces each comprise a surface area of between 0.6 cm² and 2.3 cm² and/or one larger pressing surface comprises a surface area of at least 2.5 cm². As a result, the smaller pressing surfaces can be easily pressed with a fingertip as the surface area of the smaller surfaces is adapted to the surface area of a fingerprint. The larger surface can be pressed with the thumb such that a large part of the surface of the front side is available as a pressing surface and consequently as good as possible an adhesion result is obtained.

According to another advantageous further development, it is provided that the retaining body is delimited by side edges, wherein positioning notches are realized on the side edges in each case at the same height. Consequently, simple alignment of the retaining body to a marking on a surface is possible. It is particularly advantageous, in this case, when the positioning notches are realized at the level of the carrier element as the position of the carrier element is consequently indicated by the positioning notches.

According to another advantageous further development, it is provided that a vent duct is provided on the rear surface of the retaining body. As a result, when the retaining body is attached, air located between the rear surface and the top surface is able to escape. It is particularly advantageous, in this case, when the vent duct runs at least in portions under one of the reinforcing ribs. Consequently, the pressing surfaces are not weakened by the vent duct such that the risk of damage or of deformation of the retaining body when pressing is reduced.

According to a first embodiment, the invention relates to a retaining body 3 for fastening on a surface 21, wherein the retaining body 3 is fixable on the surface 21 by means of a double-sided adhesive strip 2 with two oppositely situated adhesive surfaces, wherein the retaining body 3 comprises a basic body 16 with a flat rear surface 19 and a front surface 27 which is situated opposite the rear surface 19, wherein a carrier element 4, which protrudes out of a plane of the basic body 16, is realized on the front surface 27 of the basic body 16, wherein the basic body 16 comprises a reinforcing structure with reinforcing elements 6, 7 on the front surface 27, characterized in that the reinforcing elements 6, 7 divide the front surface 27 of the basic body 16 into at least two differently sized pressing surfaces 11, 13.

According to a second embodiment, the invention relates to a retaining body 3 as claimed in the first embodiment, characterized in that, proceeding from a point of applied force 25, there is preferably provided at least one pressing surface 11 which is arranged in the opposite direction to the main load direction and there is preferably provided at least one pressing surface 13 which is arranged in the main load direction and which is greater than the pressing surface 11 which is arranged in the opposite direction.

According to a third embodiment, the invention relates to a retaining body 3 as claimed in the first or second embodiment, characterized in that the reinforcing ribs 5, 6, 7 divide the front surface into at least three pressing surfaces 11, 12, 13.

According to a fourth embodiment, the invention relates to a retaining body 3 as claimed in one of the preceding embodiments, characterized in that a first reinforcing element 5 extends from the point of applied force 25 of the carrier element 4 counter to the main load direction.

According to a fifth embodiment, the invention relates to a retaining body 3 as claimed in one of the preceding embodiments, characterized in that a second reinforcing element 6 and a third reinforcing element 7 extend symmetrically to a symmetry plane through the retaining body 3, in particular in a mirror-symmetrical manner to a longitudinal axis parallel to the main load direction and through the carrier element 4.

According to a sixth embodiment, the invention relates to a retaining body 3 as claimed in one of the preceding embodiments, characterized in that in the view of the front surface 27 of the retaining body 3, the surface areas of the reinforcing elements 5, 6, 7 are smaller than the surface areas of the pressing surfaces 11, 12, 13.

According to a seventh embodiment, the invention relates to a retaining body 3 as claimed in one of embodiments 1 to 6, characterized in that a normal projection of the carrier element 4 onto the rear surface 19 of the retaining body 3 lies outside the corresponding normal projections of the pressing surfaces 11, 12, 13.

According to an eighth embodiment, the invention relates to a retaining body 3 as claimed in one of embodiments 1 to 7, characterized in that the basic body 16 is scarfed on one side.

According to a ninth embodiment, the invention relates to a retaining body 3 as claimed in one of embodiments 1 to 8, characterized in that the retaining body 3 is produced from a fiber-reinforced plastics material.

According to a tenth embodiment, the invention relates to a retaining body 3 as claimed in one of the preceding embodiments, characterized in that the retaining body 3 is produced on the basis of one of the following materials: polystyrene (PS), in particular a syndiotactic polystyrene (PS-S), styrene acrylonitrile (SAN), acrylonitrile-styrene-acrylate (ASA), acrylonitrile-butadiene-styrene (ABS) and polyamide (PA).

According to an eleventh embodiment, the invention relates to a retaining body 3 as claimed in one of embodiments 1 to 9, characterized in that the retaining body 3 is produced on the basis of a polyether ether ketone (PEEK), wherein the retaining body 3 is produced, in particular, by hot pressing.

According to a twelfth embodiment, the invention relates to a retaining body 3 as claimed in one of the preceding embodiments, characterized in that reinforcing elements 5, 6, 7 converge in a base 25 which is arranged in the point of applied force, wherein the carrier element 4 rises out the basic body 16 from said base 25 and the reinforcing elements 5, 6, 7 preferably extend out of the base 25 in a star-shaped or compartment-shaped manner.

According to a thirteenth embodiment, the invention relates to a retaining body 3 as claimed in one of the preceding embodiments, characterized in that the carrier element 4 is realized in the form of a sloping elliptical truncated cone or in the form of a rose thorn with a tapering end.

According to a fourteenth embodiment, the invention relates to a retaining body 3 as claimed in one of the preceding embodiments, characterized in that the carrier element 4 carries a support plate on its free end.

According to a fifteenth embodiment, the invention relates to a retaining body 3 as claimed in one of the preceding embodiments, characterized in that one smaller pressing surface 11 comprises a surface area of between 0.6 cm² and 2.3 cm² and/or two smaller pressing surfaces of the at least three pressing surfaces 11, 12 each comprise a surface area of between 0.6 cm² and 2.3 cm² and/or one larger pressing surface 13 comprises a surface area of at least 2.5 cm².

According to a sixteenth embodiment, the invention relates to a retaining body 3 as claimed in one of the preceding embodiments, characterized in that the retaining body 3 is delimited by side edges 31, 32, wherein positioning notches 14 are realized on the side edges 31, 32 in each case at the same height, in a preferred manner at the height of the carrier element 4.

According to a seventeenth embodiment, the invention relates to a retaining body 3 as claimed in one of the preceding embodiments, characterized in that a vent duct 20, which is preferably realized with a V-shaped profile, is provided on the rear surface 19 of the retaining body 3.

According to an eighteenth embodiment, the invention relates to a retaining body 3 as claimed in the seventeenth embodiment, characterized in that the vent duct 20 runs at least in portions under one of the reinforcing elements 5, 6, 7, preferably under the first reinforcing element 5.

According to a nineteenth embodiment, the invention relates to a retaining device 1 having a retaining body 3 as claimed in one of the preceding embodiments and having an adhesive strip 2, which is effective on two sides and is attached to the rear surface 19 of the basic body 16 of the retaining body 3 or is attachable to said rear surface 19.

According to a twentieth embodiment, the invention relates to a retaining device 1 as claimed in the nineteenth embodiment, characterized in that the adhesive strip 2, which is effective on two sides, comprises a non-adhesive part portion 24, wherein the non-adhesive part portion 24 projects beyond at least one side of the rear surface 19 of the basic body 16.

According to a twenty-first embodiment, the invention relates to a method for installing a retaining device 1 having a retaining body 3 as claimed in one of the preceding claims as well as an adhesive strip 2, which is effective on two sides and has two oppositely situated sticky adhesive surfaces 22, 23 which are each covered by a protective foil 28, 29, said method including the following steps:

a) remove the first protective foil 28 from the first sticky adhesive surface 22 of the adhesive strip 2 which is effective on two sides;
b) apply the first sticky adhesive surface 22 of the adhesive strip 2 onto a surface 21;
c) remove the second protective foil 29 from the second sticky adhesive surface 23 of the adhesive strip 2;
d) place the rear surface 19 of the retaining body 3 onto the second sticky adhesive surface 23 of the adhesive strip 2;
e) exert pressure onto each of the pressing surfaces 11, 12, 13 of the retaining body 3, wherein the surface moistened by one of the sticky adhesive surfaces 22, 23 of the adhesive strip 2 is increased with each exertion of pressure onto a pressing surface 11, 12, 13.

The invention is explained below by way of preferred embodiments with reference to the accompanying figures, in which:

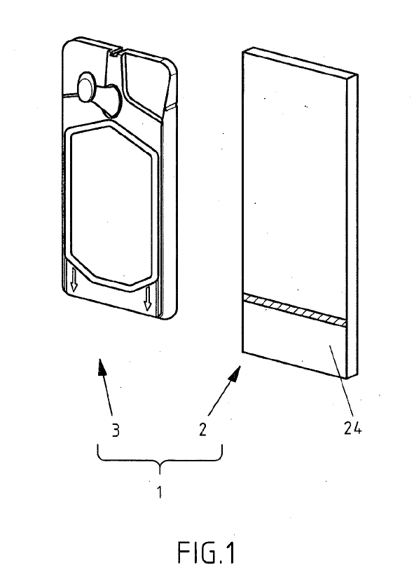

FIG. 1 shows a perspective view of a retaining device according to the invention with an adhesive strip which is effective on two sides and a retaining body according to the invention;

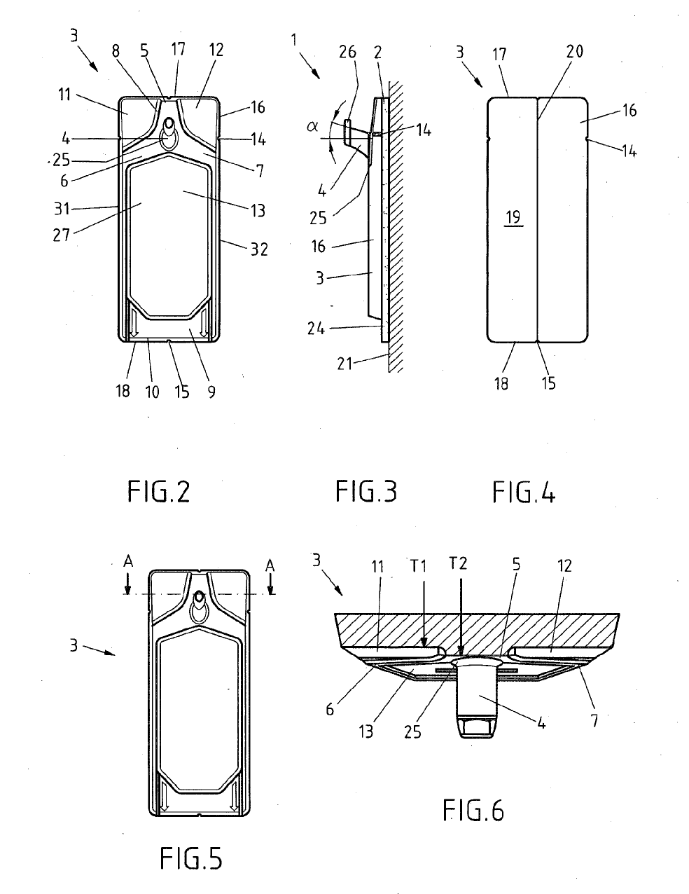

FIG. 2 shows a front view of a retaining body according to the invention;

FIG. 3 shows a side view of the retaining body according to the invention;

FIG. 4 shows a rear view of a retaining body according to the invention;

FIG. 5 shows a front view of a retaining body according to the invention identifying a section plane A-A;

FIG. 6 shows a section A-A through a retaining body according to the invention;

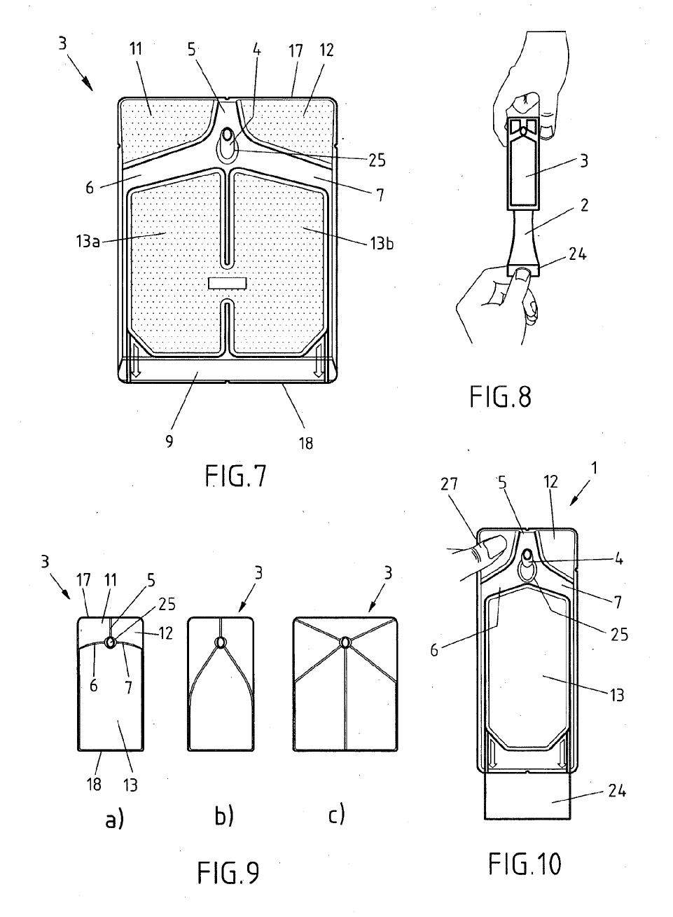

FIG. 7 shows a further exemplary embodiment of a retaining body according to the invention;

FIG. 8 shows an application example for detaching a retaining body according to the invention;

FIG. 9 shows further exemplary embodiments of retaining bodies according to the invention;

FIG. 10 shows an application example for bonding a retaining device according to the invention with a retaining body according to the invention;

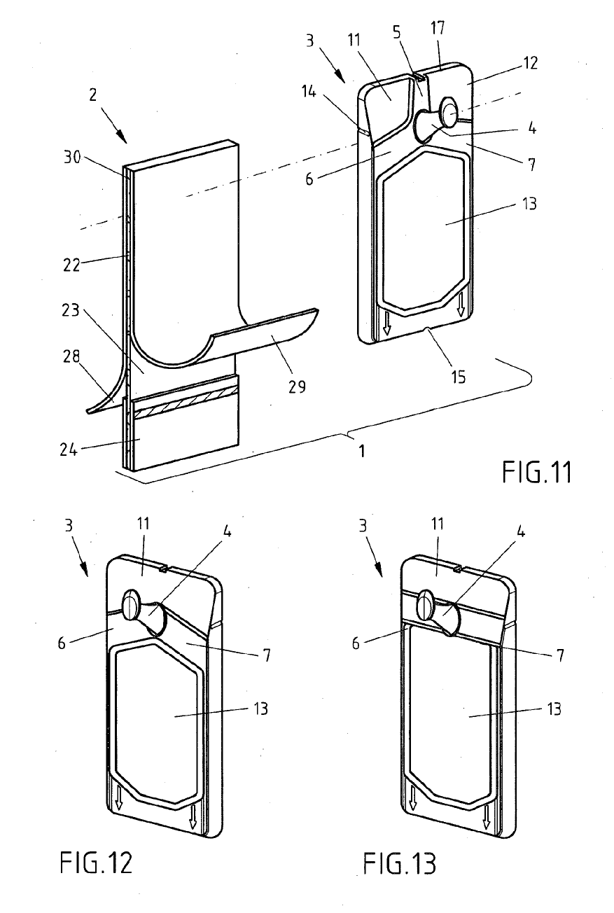

FIG. 11 shows a perspective view of a retaining device according to the invention with a retaining body according to the invention and an adhesive strip pulled undone;

FIG. 12 shows a further exemplary embodiment of a retaining body according to the invention; and

FIG. 13 shows a further exemplary embodiment of a retaining body according to the invention.

In principle, the retaining body 3 can be fastened on an arbitrarily oriented surface 21. Within the framework of the description of the figures, it is assumed without limiting generality that a retaining body 3 is attached to a vertical (component) surface 21, for example a wall. Directional specifications such as “above” or “below” refer to a retaining body 3 which is positioned in such a manner. Identical components or component portions are characterized with identical reference signs in the following description of the figures.

FIG. 1 shows a perspective view of a retaining device 1 according to the invention having an adhesive strip 2, which is effective on two sides, and a retaining body 3 according to the invention. To attach the retaining body 3, the user will first of all stick the adhesive strip 2, which is effective on two sides, at a desired position on a surface 21 and then press the retaining body 3 onto the adhesive strip 2. As an alternative to this, the adhesive strip 2, by way of a first adhesive surface 22, can also first of all be bonded with a rear surface 19 of the retaining body 3, and then, by way of its second adhesive surface 23 which is situated opposite the first adhesive surface 22, can be bonded to the surface 21. As a further alternative to this, the adhesive strip 2, by way of one of the two adhesive surfaces 22, can already be bonded 23 with the rear surface 19 of the retaining body 3, the adhesive surface 22, 23 remote from the rear surface 19 of the retaining body 3 being provided with a protective foil 28, 29.

The retaining body 3 comprises a, preferably cuboid, basic body 16 with a flat, level rear surface 19 and a front surface 27 which is situated opposite the rear surface 19. The outer contour of the retaining body 3 is realized preferably in a substantially rectangular manner in the projection plane of the front surface 27, an upper edge 17 and a lower edge 18, which is located opposite the upper edge 17, being aligned horizontally after installation. In addition, two side edges 31, 32, which each extend from the upper edge 17 to the lower edge 18 and thus delimit the basic body 16 in the vertical direction, are realized on the basic body 16. The retaining body 3 is preferably symmetrical to a plane, which is oriented normally to the rear surface 19 of the retaining body 3, and runs through a center straight line which is between the side edges 31, 32.

Other forms of the basic body 16, in particular with an oval or elliptical projection surface, are also possible as an alternative to this.

As shown in FIG. 2, a carrier element 4, which, proceeding from an oval or elliptical base 25, is realized centrally between the side edges 31, 32, protrudes from a plane of the basic body 16 on the front surface 27. The distance between the base 25 of the carrier element 4 and the upper edge 17 is smaller than the distance between the base 25 and the lower edge 18. In many cases, the user wishes for aesthetic reasons that the retaining body 3 is covered by an object which is retained thereon. As the retaining body 3 cannot be arbitrarily small in view of a rear surface 19 or adhesive surface that is ideally as large as possible, this is achieved simply by the carrier element 4 being arranged as close as possible to the upper edge 17 of the retaining body 3.

The carrier element 4 comprises, in a preferred manner, the form of a sloping truncated cone with an oval or elliptical base area. A straight line through two points on the top side of the carrier element 4, which at the same time provide contact points from the horizontal tangents of the lateral surface thereof, encloses an angle of between 0° and 90°, in a preferred manner between 0° and 20°, with a horizontal plane. A positive angle brings about a gradient toward the basic body 16 such that an object suspended on the retaining device 3 is pulled by gravity in the direction of the basic body 16, as a result of which a tilt moment with reference to a region of the adhesion which is below the carrier element 4 in the projection plane of the front surface 27 is reduced.

The carrier element 4 is advantageously realized such that it is able to be utilized with a plurality of fastening systems such as, for instance, picture hangers, folding eyelets, cables or saw-tooth hangers, and there is no need for a separate adapter for suspending an object. Consequently, a diameter of the carrier element 4 should not be too large so that objects with small fastening eyelets are also able to be suspended thereon. The dimension of the carrier element 4 toward small, however, is also delimited by the strength of the material as a very narrowly dimensioned carrier element 4 is, as a rule, able to carry less weight. The retaining body 3 should comprise a high resistance moment against deformation and, in particular, deflection.

A reinforcing structure 5, 6, 7, 25, which is connected non-detachably to the basic body 16, is realized on the front surface 27 of the retaining body 3. The reinforcing structure 5, 6, 7, 25 includes three reinforcing ribs 5, 6, 7 which join together in a region around the base 25 or realize said base together in an integral manner.

The first reinforcing rib 5 preferably extends in a straight manner between the base 25 of the carrier element 4 and the upper edge 17 of the retaining body 3. The second reinforcing rib 6, proceeding from a region which adjoins the base 25 at the side, first of all extends in the direction of the side edge 31 and continues along the side edge 31 up to the lower edge 18. The third reinforcing rib 7 corresponds to an axiallysymmetrical mirroring of the second reinforcing rib 6 along a longitudinal axis which extends through the base 25 and, proceeding from the region which adjoins the base 25 at the side, first of all leads in the direction of the side edge 32 and continues parallel to the second reinforcing rib 6 along the side edge 32 up to the lower edge 18.

The reinforcing ribs 5, 6, 7 divide the front surface of the retaining body 3 into three pressing surfaces 11, 12, 13 which are set back relative to the reinforcing ribs 5, 6, 7 and have a thinner wall thickness. A first pressing surface 11 is delimited by the first reinforcing rib 5, a first portion of the second reinforcing rib 6, the upper edge 17 and a region of the side edge 31. A second pressing surface 12, with reference to a mirroring along a longitudinal axis which extends through the base 25, is mirror-symmetrical to the first pressing surface 11 and is delimited by the first reinforcing rib 5, a first portion of the third reinforcing rib 7, the upper edge 17 and a region of the side edge 32.

The pressing surfaces 11, 12 defined by the reinforcing ribs 5, 6, 7 comprise a form which is inspired by a curved part outline of a fingertip. The first pressing surface 11 and the second pressing surface 12, in this case, are the same size and preferably comprise a surface area each of between 0.6 cm² and 2.3 cm². The surfaces of the first and of the second pressing surfaces 11, 12 are each smaller than the surface of the third pressing surface 13. The first and the second pressing surfaces 11, 12 are designated as upper pressing surfaces and the pressing surface 13 as the lower pressing surface. In a preferred manner, the first and the second pressing surfaces 11, 12, with in each case less than 2.3 cm², are smaller than the average surface of a fingerprint such that during adhesion, when the retaining body 3 is pressed, the pressing pressure can be increased in this region compared to a full-surface contact of a fingertip. The size of the first and second pressing surfaces 11, 12, in this case, should not fall below 0.6 cm² as it has been shown that, when installing the retaining body 3, the pressing force on the side of the user is otherwise reduced in an unwanted manner on account of a feeling of pain in the fingertip.

In order to ensure that the fingertips are able to reach the pressing surfaces 11, 12, 13, it is advantageous when the normal projection of the carrier element 4 onto the rear surface 19 of the retaining body 3 lies outside the corresponding normal projection of the pressing surfaces 11, 12, 13.

The third pressing surface 13 lies under the second and third reinforcing ribs 6, 7 and is delimited by the lower edge 18 and the side edges 31, 32 of the retaining body 3. The third pressing surface 13, in this case, is greater than one of the other pressing surfaces 11, 12 and comprises a surface area of at least 2.5 cm². The surface areas of all the reinforcing ribs 5, 6, 7 are smaller than the surface areas of all the pressing surfaces 11, 12, 13.

In order to reduce stress maxima in the upper region of the adhesive strip 2, one-sided scarfing of the basic body 16 can be provided. One-sided scarfing is to be understood, in this context, as tapering of the cross section of the basic body 16 in the upward direction. As shown in FIG. 3, the cross section of the basic body 16 tapers in a preferred manner in the region from the lower shoulder of the base 25 of the carrier element 4 up to the upper edge 17 of the basic body 16. In a particularly preferred manner, the wall thickness of the pressing surfaces 11, 12 tapers as the height coordinates rise, as shown in FIG. 6, whilst the difference between the wall thickness of the first reinforcing rib 5, which is arranged in said region, and the wall thickness of one of the adjacent pressing surfaces 11, 12 remains constant.

For simplified positioning, positioning notches 14 can be provided on the oppositely situated side edges 31, 32 at the identical height, as shown in FIG. 2 and FIG. 3. They lie on a horizontal tangent which contacts the lateral surface of the carrier element 4 at the transition between the base 25 and the carrier element 4. The positioning notches 14 serve for positioning the retaining body 3 in a vertical manner, said retaining body consequently being able to be installed relative to a vertical coordinate or to a fixed reference point. In an analogous manner, positioning notches 15 can be provided in the center of the upper edge 17 and the center of the lower edge 18 for horizontal alignment.

As shown in FIG. 3, a support plate 26 can be arranged or integrally molded on the free end of the carrier element 4. A region of the support plate 26 projects beyond the carrier element 4. In order also to be able to hang objects with very small eyelets on the carrier element 4, the support plate 26 can be connected to the carrier element 4 so as to be detachable, for example as a result of a plug or threaded connection. As an alternative to this, the carrier element 4 can also be developed in a tapering manner in the form of a rose thorn. The carrier element 4, in this case, preferably comprises an angle α of approximately between 10° and 20° to a normal through the base 25, as a result of which an object suspended on the carrier element 4 is able to slip in the direction of the base 25 as a result of gravity acting on the object.

FIG. 4 shows the rear surface 19 of the retaining body 3. A vent duct 20, which is preferably realized in a V-shaped manner in profile, is realized on the rear surface 19. The vent duct 20 serves for the purpose of avoiding air pockets between the adhesive layer of the adhesive strip 2, which has two effective sides, and the rear surface 19 of the retaining body 3.

FIG. 10 shows the installation of a retaining device 1 according to the invention. To this end, the user presses each of the three pressing surfaces 11, 12, 13 one after the other with a fingertip, the surface regions of the surface 21 or of the rear surface 19 of the retaining body 3 moistened by the adhesive surfaces 22, 23 of the adhesive strip 2 being enlarged with each pressing. Consequently, the retaining power of the adhesive strip 2, which is effective on two sides and retains the retaining body 3 on the surface 21, is increased, which improves the user characteristics of the retaining device 1 overall.

FIGS. 9a, 9b and 9c show further embodiments of a retaining body 3 according to the invention. In the case of all of the embodiments, the front surface 27 of the retaining body 3 is divided by reinforcing ribs 5, 6, 7 into several pressing surfaces 11, 12, 13, the reinforcing ribs 5, 6, 7 extending in each case through the base 25 of the carrier element 4 or being placed on said base 25. Stress maxima, which occur especially in the transition region between the carrier element 4 and the basic body 16, are absorbed by the reinforcing ribs 5, 6, 7 and are directed into the retaining body 3 without it resulting in material failure. In addition, the reinforcing ribs 5, 6, 7 increase the flexural rigidity and the resistance moment of the retaining body 3, which wants to deform about a horizontal axis as a result of the weight of the suspended object engaged on the carrier element 4.

As shown in FIG. 5 and FIG. 6, the wall thickness of the retaining body 3 in the region of the reinforcing ribs 5, 6, 7 is greater than the wall thickness in the region of the pressing surfaces 11, 12, 13.

FIG. 7 shows a wider realization of the retaining body 3 which can be attached on a surface 21 by means of two adhesive strips which are arranged side by side in parallel and are effective on two sides. The pressing surfaces 11, 12, 13a, 13b are realized in said realization with a haptically palpable structure. Such structures can be generated, for example, in conjunction with etched or engraved surfaces. A further option consists in the grid-like arrangement of a plurality of raised hemispherical or disk-shaped elements with a diameter of between 0.1 mm and 3 mm and a relative distance between one another of between 0.7 mm and 6 mm. The structure can also have a communicative or directing function and, for example, evoke a fingerprint. This can serve as support during use.

Described below, as shown in FIG. 11, is the bonding of the retaining device 1 with a retaining body 3 and an adhesive strip which is effective on two sides. A frequent challenge when attaching devices which are fastened on a surface 21 by means of adhesive strips 2, which are effective on two sides, is to provide a sufficient pressing force during adhesion, which pressing force is to be effective additionally on the sticky adhesive surfaces 22, 23 of the adhesive strip 2 as a whole. It is known from tests that, in the majority of cases, a user attaches a retaining body 3 with an adhesive strip 2 attached on the rear side by pressing once onto the front surface 27 of the retaining body 3 with the tip of the thumb and at a force of between 30 and 80 Newtons. The average surface of a fingerprint is within the range of between 2 cm² and 3 cm², as a result of which, with reference to the contact surface between retaining body 3 and fingertip, a pressure region of between 100 kPa and 400 kPa is produced. This means in the case of retaining bodies disclosed in the prior art that the pressing force, which is exerted only once, is distributed in a first approximation onto the surface of the adhesive strip 2 which is situated between the external surface 21 and the retaining body 3 and is effective on two sides. If a smaller pressing force of 30 Newtons is assumed, a pressure of only just 30 kPa in the case of an adhesive strip 2 with a surface of 10 cm² would be the result. Reliable moistening of the substrate by the adhesive of the adhesive strip 2, in particular on a rough surface 21, is no longer ensured in the case of said low pressure. In this case, said estimation does not take into consideration any further effects, such as loss through deformation of the adhesive strip 2, which reduce the effective pressure on the adhesive surfaces 22, 23. Part-plastic deformation of the adhesive strip 2 can be desired as typical surfaces 21, on which the retaining device 1 is used, are not ideally smooth and part-plastic deformation enables adaptation to the real outline of the surface 21 within certain boundaries.

In the case of the retaining device 1 according to the invention with the retaining body 3 according to the invention, the pressing surface available overall is increased by the three pressing surfaces 11, 12, 13. Where the force expended is the same and there is a pressing force of 30 Newtons, the pressing pressure is increased to between 50 kPa and 70 kPa when the three pressing surfaces 11, 12, 13 are pressed, as a result of which a substantially improved bonding result is obtained.

To fix the retaining device, first of all a first protective foil 28 is removed from a first adhesive surface 22 of the adhesive strip 2, which is effective on two sides, and the adhesive strip is aligned to the wall by way of the exposed adhesive surface 22. Then, as a result of pressure onto the side of the adhesive strip 2 located opposite the free adhesive surface 22, the adhesive strip 2 is bonded with the surface 21. A second protective foil 29, which covers a second adhesive surface 23 of the adhesive strip 2, which is effective on two sides, is then detached from the adhesive strip 2. The retaining body 3 can then be positioned with its rear surface 19 covering over the second adhesive surface 23 of the adhesive strip 2 and pressed. In order to achieve good moistening of the surfaces 19, 21 contacted by the adhesive surfaces 22, 23, pressure is exerted onto the first pressing surface 11 for several seconds with the tip of the thumb. Pressure is then exerted for several seconds onto the second pressing surface 12 and finally pressure is exerted for several seconds onto the third pressing surface 13 with the tip of the thumb. As an alternative to this, pressure can also be exerted onto the third pressure surface 13 with the tip of the thumb and pressure can be exerted in parallel onto the first and second pressing surfaces 11, 12 with the fingertips of two further fingers.

As an alternative to this, one of the protective foils 28, 29 of the adhesive strip 2 or the adhesive strip 2 itself can be marked or can carry a notch for precise positioning. Consequently, the positioning notches 14, 15 on the retaining body 3 can be moved to coincide with the positioning notches on the adhesive strip or can be aligned with said positioning notches.

A further option for positioning the retaining body 3 in relation to the adhesive strip 2 consists in first of all placing the upper edge 17 of the retaining body 3, which is set at an angle, on an upper edge 30 of the adhesive strip 2. With the upper edges 17, 30 being placed one on top of the other, the angle between the external surface 21 and the rear surface 19 of the retaining body 3 is then reduced until the retaining body 3 rests with its rear surface 19 on the second adhesive surface 23 of the adhesive strip 2.

In an advantageous manner, the retaining body 3 can be detached from the surface 21 without trace and residue and without damaging the surface 21 and/or the retaining body 3. As shown in FIG. 8, this can be achieved with known pull-release adhesive strips 2 which can be detached from the adhesive join between the surface 21 and the retaining body 3 by pulling on a protruding, non-adhering part portion 24 of the adhesive strip 2 in the direction of the adhesion plane.

A plastics material, which can be selected in dependence on various factors and sites of operation, is provided as the production material of the retaining body 3. In particular, the production material should be compatible with the adhesive composition of the adhesive strip 2 and should adhere reliably thereto. In addition, the production material should comprise resistance to the most common environmental influences, such as moisture, UV radiation or ozone and exhaust emissions, without its material characteristics being substantially impaired over a suitable period. Low water absorption is desirable for use in wet cells as water absorption of the retaining body as a rule weakens the quality of the adhesion.

A material which is compatible with adhesive strip, which are based on styrene compounds with standard industrial adhesive resins and further additives is polystyrene. The disadvantageous tendency to form stresses can be reduced by using special qualities, such as high impact polystyrene (HIPS), such as, for example, polystyrene 432B. As an alternative to this, it is possible to use glass fiber-reinforced polystyrene grades, both syndiotactic polystyrene and normal polystyrene being able to be used. In a preferred manner, the (glass) fiber proportion is between 10% and 50%, in a particularly preferred manner between 20% and 40%, of the filler content such as, for example, in the case of the syndiotactic type Schulatec PS-S-GF 40. Determination of the filler content of reinforcing fibers can be found in DIN EN ISO 11667. Styrene acrylonitrile (SAN), acrylonitrile-styrene-acrylate (ASA), acrylonitrile-butadiene-styrene (ABS) and glass fiber-reinforced acrylonitrile-styrene-acrylate are also suitable as production materials. As an alternative to this, carbon fiber-reinforced plastics materials, in particular carbon fiber-reinforced epoxy resins or carbon fiber-reinforced polyether ether ketone (PEEK), can also be used.

As an alternative to this, the retaining body 3 can also be realized from steel, in particular high-grade steel, an aluminum alloy or a titanium alloy.

FIG. 12 shows a further exemplary embodiment of a retaining body 3 according to the invention. With the design being identical to FIG. 2 to the greatest possible extent, only the differences will be looked into below. In a simplified version, the reinforcing rib 5 is omitted such that the retaining body 3 only comprises two pressing surfaces 11, 13, the upper pressing surface 11 extending over the entire width of the retaining body 3 and not being divided into two pressing surfaces, as in FIG. 2, by the vertically extending reinforcing rib. As an alternative to this, in the case of a simple embodiment with only two pressing surfaces, the reinforcing ribs 6, 7 can also be replaced by horizontally extending reinforcing ribs. As a result of the upper pressing surface 11 being smaller than the lower pressing surface 13, it is also achieved in the case of the embodiments according to FIG. 11 and FIG. 12 that, as a result of the small pressing surface, the retaining body 3 experiences a greater surface pressing during pressing in the particularly strongly exposed region above the carrier element 4 such that a better adhesion result is obtained.

### LIST OF REFERENCES

1 Retaining device
2 Adhesive strip
3 Retaining body
4 Carrier element
5 Reinforcing ribs
6 Reinforcing element
7 Reinforcing element
11 Pressing surface
12 Pressing surface
13 Pressing surface
14 Positioning notches
16 Basic body
19 Rear surface
20 Vent duct
21 Surface
22 Sticky adhesive surface
23 Sticky adhesive surface
24 Non-adhering part portion
25 Point of applied force/base
27 Front surface
28 Protective foil
29 Protective foil
31 Side edge
32 Side edge

1. A retaining body for fastening on a surface, wherein the retaining body is fixable on the surface by means of a double-sided adhesive strip with two oppositely situated adhesive surfaces, wherein the retaining body comprises a basic body with a flat rear surface and a front surface which is located opposite the rear surface, wherein a carrier element, which protrudes from a plane of the basic body, is realized on the front surface of the basic body, wherein the basic body comprises a reinforcing structure with reinforcing elements on the front surface, wherein the reinforcing elements are formed in one piece with and on the retaining body and divide the front surface of the basic body into at least two differently sized pressing surfaces, wherein, proceeding from a point of applied force, there is optionally provided at least one pressing surface which is arranged in the opposite direction to the main load direction and there is optionally provided at least one pressing surface which is arranged in the main load direction and which is greater than the pressing surface which is arranged in the opposite direction.

2. The retaining body as claimed in claim 1, wherein the reinforcing ribs divide the front surface into at least three pressing surfaces.

3. The retaining body as claimed in claim 1, wherein a first reinforcing element extends from the point of applied force of the carrier element counter to the main load direction.

4. The retaining body as claimed in claim 1, wherein a second reinforcing element and a third reinforcing element extend symmetrically to a symmetry plane through the retaining body, optionally in a mirror-symmetrical manner to a longitudinal axis parallel to the main load direction and through the carrier element.

5. The retaining body as claimed in claim 1, wherein in the view of the front surface of the retaining body, the surface areas of the reinforcing elements are smaller than the surface areas of the pressing surfaces.

6. The retaining body as claimed in claim 1, wherein a normal projection of the carrier element onto the rear surface of the retaining body lies outside the corresponding normal projections of the pressing surfaces.

7. The retaining body as claimed in claim 1, wherein the basic body is scarfed on one side.

8. The retaining body as claimed in claim 1, wherein the retaining body is produced from a fiber-reinforced plastics material.

9. The retaining body as claimed in claim 1, wherein the retaining body is produced on the basis of one of the following materials: polystyrene (PS), optionally a syndiotactic polystyrene (PS-S), styrene acrylonitrile (SAN), acrylonitrile-styrene-acrylate (ASA), acrylonitrile-butadiene-styrene (ABS) and polyamide (PA).

10. The retaining body as claimed in claim 1, wherein the retaining body is produced on the basis of a polyether ether ketone (PEEK), wherein the retaining body is produced, optionally, by hot pressing.

11. The retaining body as claimed in claim 1, wherein reinforcing elements converge in a base which is arranged in the point of applied force, wherein the carrier element rises out the basic body from said base and the reinforcing elements preferably extend out of the base in a star-shaped or compartment-shaped manner.

12. The retaining body as claimed in claim 1, wherein the carrier element is realized in the form of a sloping elliptical truncated cone or in the form of a rose thorn with a tapering end.

13. The retaining body as claimed in claim 1, wherein the carrier element carries a support plate on its free end.

14. The retaining body as claimed in claim 1, wherein one smaller pressing surface comprises a surface area of between 0.6 cm² and 2.3 cm² and/or two smaller pressing surfaces of the at least three pressing surfaces each comprise a surface area of between 0.6 cm² and 2.3 cm² and/or one larger pressing surface comprises a surface area of at least 2.5 cm².

15. The retaining body as claimed in claim 1, wherein the retaining body is delimited by side edges, wherein positioning notches are realized on the side edges in each case at the same height, optionally at the height of the carrier element.

16. The retaining body as claimed in claim 1, wherein a vent duct which is realized with a V-shaped profile, is provided on the rear surface of the retaining body.

17. The retaining body as claimed in claim 16, wherein the vent duct runs at least in portions under one of the reinforcing elements under the first reinforcing element.

18. A retaining device with a retaining body as claimed in claim 1 and with an adhesive strip which is effective on two sides and is attached on the rear surface of the basic body of the retaining body or on said rear surface.

19. The retaining device as claimed in claim 18, wherein the adhesive strip, which is effective on two sides, comprises a non-adhesive part portion, wherein the non-adhesive part portion projects beyond at least one side of the rear surface of the basic body.

20. A method for installing a retaining device having a retaining body as claimed in claim 1 as well as an adhesive strip, which is effective on two sides and has two oppositely situated sticky adhesive surfaces which are each covered by a protective foil, said method comprising the following steps:
a) moving the first protective foil from the first sticky adhesive surface of the adhesive strip which is effective on two sides;
b) applying the first sticky adhesive surface of the adhesive strip onto a surface;
c) removing the second protective foil from the second sticky adhesive surface of the adhesive strip;
d) placing the rear surface of the retaining body onto the second sticky adhesive surface of the adhesive strip;
e) exerting pressure onto each of the pressing surfaces of the retaining body, wherein the surface moistened by one of the sticky adhesive surfaces of the adhesive strip increases with each exertion of pressure onto a pressing surface.
